(19) United States
(12) Patent Application Publication
(10) Pub. No.: US 2022/0234175 A1
(43) Pub. Date: Jul. 28, 2022

(54) PANEL CUTTING JIG

(71) Applicant: RICO BLINDS CO., LTD., Gwangju-si (KR)

(72) Inventors: Sang Gon KIM, Gwangju-si (KR); Jong Woo LEE, Seoul (KR)

(73) Assignee: RICO BLINDS CO., LTD., Gwangju-si (KR)

(21) Appl. No.: 17/459,622

(22) Filed: Aug. 27, 2021

(30) Foreign Application Priority Data
Jan. 22, 2021 (KR) 10-2021-0009327

(51) Int. Cl. B25B 11/02

(52) U.S. Cl. CPC B25B 11/02

(57) ABSTRACT

The present disclosure relates to a panel cutting jig including: a main body having an insertion channel, into which a plate-shaped panel is inserted, formed therein; and a holder that is elastically deformable and supports the main body to generate elastic force toward the insertion channel.

### CROSS-REFERENCE TO RELATED APPLICATION

A claim for priority under 35 U.S.C. § 119 is made to Korean Patent Application No. 10-2021-0009327 filed on Jan. 22, 2021 in the Korean Intellectual Property Office, the entire contents of which are hereby incorporated by reference.

### BACKGROUND

### 1. Technical Field

The present disclosure relates to a panel cutting jig capable of stably fixing and cutting a plate-shaped panel.

### 2. Description of Related Art

In general, among the panel-like panels, wood panels include plywood, Medium Density Fiber (MDF) panels, Low Pressure Melamine (LPM) panels (Panel), as well as Particle Board (PB) panels, and are widely used as various building materials and furniture materials.

These wood panels have high strength as well as good workability, and are suitable for bonding patterned sheets, so they have been widely used in recent years.

The wood panel is cut to a specific size to be suitably sized for use in various construction sites or industrial sites. In general, the wood panel is cut by being fixed by a worker's hand. As a result, as the wood panel is unstably fixed and cut, the cutting surface of the wood panel may be uneven.

### SUMMARY

The present disclosure has been devised to obviate the above limitation. An aspect of the present disclosure is directed to providing a panel cutting jig capable of stably fixing and cutting a plate-shaped panel and making the cutting surface of the panel even.

The aspects of the present disclosure are not limited to those mentioned above, and other aspects not mentioned will be clearly understood by those skilled in the art from the following description.

A panel cutting jig according to an embodiment of the present disclosure includes: a main body having an insertion channel, into which a plate-shaped panel is inserted, formed therein; and a holder that is elastically deformable and supports the main body to generate elastic force toward the insertion channel.

In addition, the panel cutting jig may further include a stress dispersion unit which is provided in the holder and disperses stress due to elastic deformation of the holder.

In addition, the panel cutting jig may further include a holder separation unit which is provided in the holder and separates the holder from the insertion channel.

In addition, the main body may include a first body; and a second body detachably coupled to the first body, wherein the insertion channel may be formed between the first body and the second body.

In addition, a first opening in which the holder is disposed may be formed in any one of the first body and the second body, and a second opening facing the holder may be formed in the other of the first body and the second body.

In addition, a fixing hole may be formed in one side of any one of the first body and the second body, a fixing protrusion inserted into the fixing hole may be formed in one side of the other of one side of the first body and the second body. A bearing wall may be formed in the other side of any one of the first body and the second body, and a support wall borne by the bearing wall may be formed in the other side of any one of the first body and the second body.

In addition, a locking hole may be formed in the bearing wall, and a locking projection locked and fixed to the locking hole may be formed in the support wall.

In addition, a scale may be marked in one side of at least any one of the first body and the second body in a length direction of the main body.

In addition, a cutting guide for guiding cutting of the panel inserted into the insertion channel may be provided at the main body.

In addition, a panel insertion hole for guiding insertion into the insertion channel may be provided at the main body.

Other specific details of the present disclosure are included in the detailed description and drawings.

The panel cutting jig according to an embodiment of the present disclosure has the advantage of being able to stably fix and cut a panel and make the cutting surface of the panel even.

The advantages of the present disclosure are not limited to those mentioned above, and other advantages not mentioned herein will be clearly understood by those skilled in the art from the following description.

### BRIEF DESCRIPTION OF THE DRAWINGS

FIG. 1 is a perspective view illustrating a panel cutting jig according to an embodiment of the present disclosure.

FIG. 2 is an exploded perspective view illustrating a panel cutting jig according to an embodiment of the present disclosure.

FIGS. 3 to 7 are operational views of the panel cutting jig according to an embodiment of the present disclosure.

FIG. 8 is a perspective view illustrating a panel cutting jig according to another embodiment of the present disclosure.

FIG. 9 is another operational view of the panel cutting jig according to an embodiment of the present disclosure.

### DETAILED DESCRIPTION

The advantages and features of the present disclosure and methods of achieving them will be apparent from the embodiments that will be described in detail with reference to the accompanying drawings. It should be noted, however, that the present disclosure is not limited to the following embodiments, and may be implemented in various different forms. Rather the embodiments are provided so that this disclosure will be thorough and complete and will fully convey the scope of the present disclosure to those skilled in the technical field to which the present disclosure pertains, and the present disclosure will only be defined by the appended claims.

Terms used in the specification are used to describe embodiments of the present disclosure and are not intended to limit the scope of the present disclosure. In the specification, the terms of a singular form may include plural forms unless otherwise specified. The expressions “comprise” and/or “comprising” used herein indicate the existence of one or more other elements other than stated elements but do not exclude presence of additional elements. Like reference denotations refer to like elements throughout the specification. As used herein, the term “and/or” includes each and all combinations of one or more of the mentioned elements. It will be understood that, although the terms “first”, “second”, etc., may be used herein to describe various elements, these elements should not be limited by these terms. These terms are only used to distinguish one element from another element. Accordingly, a first element mentioned below could be termed a second element without departing from the technical ideas of the present disclosure.

Unless otherwise defined, all terms (including technical and scientific terms) used herein have the same meaning as commonly understood by those skilled in the technical field to which the present disclosure pertains. It will be further understood that terms, such as those defined in commonly used dictionaries, should not be interpreted in an idealized or overly formal sense unless expressly so defined herein.

Hereinafter, the embodiments of the present disclosure will be described in detail with reference to the accompanying drawings.

In addition, it is clarified in advance that the panel below has a plate shape of a certain thickness, and the material of the panel may include any one of wood, cardboard, and synthetic resin materials.

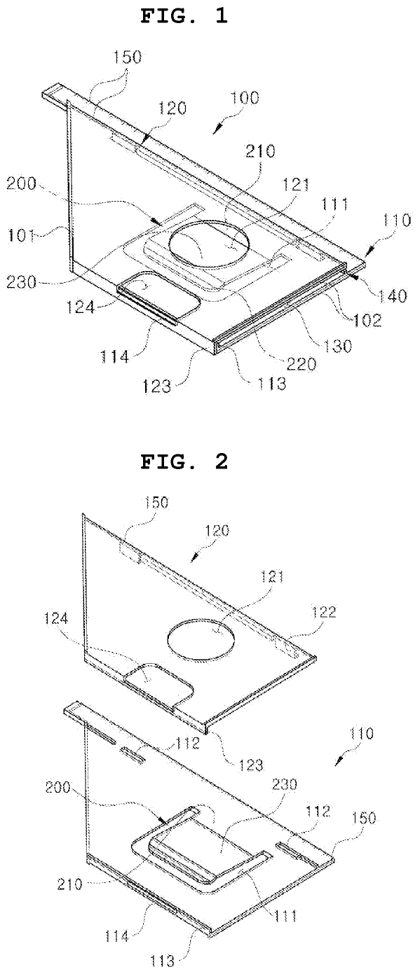

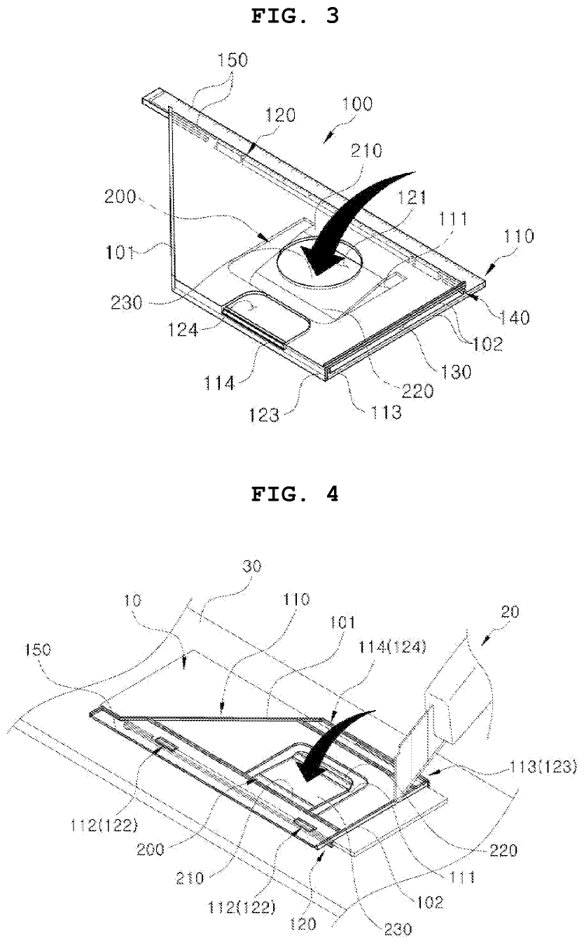

FIG. 1 is a perspective view illustrating a panel cutting jig according to an embodiment of the present disclosure. FIG. 2 is an exploded perspective view illustrating a panel cutting jig according to an embodiment of the present disclosure.

As illustrated in FIGS. 1 to 2, the panel cutting jig according to an embodiment of the present disclosure includes a main body 100 and a holder 200. Overall, the main body 100 serves to accommodate the panel 10, and the holder 200 applies elastic force to press the panel 10 inserted into the main body 100, thereby serving to fix the panel inserted into the main body 100 to the main body 100. Accordingly, a user can cut the panel 10 while the panel 10 inserted into the main body 100 is fixed by the elastic force of the holder 200. The cutting of the panel 10 may be made with an electric saw or a manual saw.

The main body 100 is formed with an insertion channel 130 into which the panel 10 is inserted. This main body 100 may be formed in a rectangular frame shape as a whole. A cutting guide 102 formed perpendicular to the length direction of the main body 100 and guiding the cutting of the panel 10 inserted into the insertion channel 130 may be provided at one end of the main body 100. In addition, the other end of the main body 100 may be provided with a panel insertion hole 101 formed to be inclined in a length direction of the main body 100 to guide the insertion into the insertion channel 130 of the panel 10.

The material of the main body 100 is not particularly limited, but may be formed of, for example, High Density Polyethylene (HDPE).

The main body 100 may be separated into a first body 110 covering one side of the insertion channel 130 and a second body 120 covering the other side of the insertion panel. Specifically, the first body 110 and the second body 120 are stacked side by side, and in this way, the insertion channel 130 may be formed between the stacked first body 110 and the second body 120.

Furthermore, the first body 110 and the second body 120 may be coupled to each other in a separable manner.

For example, as a fixing hole 112 is formed in one side of the first body 110 and a fixing protrusion 122 inserted into the fixing hole 112 is formed in one side of the second body 120. Accordingly, one side of the first body 110 and one side of the second body 120 may be detachably coupled. The fixing hole 112 may be formed in a plate shape, and the fixing protrusion 122 may be formed in a hook shape. Accordingly, after the fixing protrusion 122 is inserted into the fixing hole 112, the fixing projection 122 may be locked and fixed in the fixing hole 112 by the hook shape of the fixing projection 122.

In addition, as a support wall 113 is formed in the other side of the first body 110 and the bearing wall 123 borne by the support wall 113 is formed in the other side of the second body 120, the other side of the first body 110 and the other side of the second body 120 may be detachably coupled in a manner such that the support wall 113 is borne by the bearing wall 123. The support wall 113 may be vertically bent and extended from the other edge of the first body 110, and the bearing wall 123 may be vertically bent and extended from the other edge of the second body 120.

Moreover, a locking projection 114 may be formed on the support wall 113, and a locking hole 124 through which the locking protrusion 114 may be locked and fixed may be formed on the bearing wall 123. Accordingly, when the support wall 113 is borne by the bearing wall 123, as the locking protrusion 114 of the support wall 113 is locked and fixed to the locking hole 124 of the support wall 123, the support wall 113 and the bearing wall 123 may be prevented from being separated.

A scale may be marked in at least one side of the first body 110 and the second body 120 in a length direction of the main body 100. When scales are displayed in each of one side of the first body 110 and in one side of the second body 120, the scales displayed in one side of the first body 110 and the scales displayed in one side of the second body 120 may be displayed in each different unit. For example, a scale marked in one side of the first body 110 may be displayed in centimeter units, and a scale marked in one side of the second body 120 may be displayed in inches.

A stepped unit 140 may be formed in one side of the first body 110 and one side of the second body 120. Accordingly, a user may check and display the cut dimensions and cut portions of the panel 10 while the panel 10 is stably mounted on the stepped unit 140.

A first opening 111 in which the holder 200 is disposed may be formed in any one of the first body 110 and the second body 120, and a second opening 121 facing the holder 200 may be formed in the other of the first body 110 and the second body 120. The first opening 111 may be formed in a plate shape, and the second opening 121 may be formed in a circular shape. The holder 200 penetrates into the insertion channel 130 between the first body 110 and the second body 120. Accordingly, when the panel 10 is inserted into the insertion channel 130, interference may occur between the holder 200 and the panel 10. Therefore, before the panel 10 is inserted into the insertion channel 130, it is preferred that force for discharging the holder 200 from the insertion channel 130 through the second opening 121 is applied to discharge the holder 200 from the insertion channel 130. As such, when the holder 200 is discharged from the insertion channel 130, it is possible to prevent interference between the holder 200 and the panel 10 from occurring when the panel 10 is inserted into the insertion channel 130.

The holder 200 is elastically deformable and supports the main body 100, and elastic force is generated toward the insertion channel 130. In addition, the holder 200 applies elastic force to press the panel 10 inserted into the insertion channel 130. The holder 200 may be supported on the inner surface of the first opening 111 of the first body 110.

One end of the holder 200 may be provided with a stress dispersion unit 210 that is supports the main body 100 and is formed in parallel with the insertion channel 130 to disperse the stress caused by the elastic deformation of the holder 200. For example, the stress dispersion unit 210 may be formed in the form of a plate parallel to the insertion channel 130, and serves to prevent the holder 200 from breaking by dispersing stress due to elastic deformation of the holder 200.

There is provided a holder separation unit 220 capable of applying force for discharging the holder 200 from the insertion channel 130 while the holder 200 applies elastic force to the panel 10 inserted into the insertion channel 130 to the other end of the holder 200. For example, the holder separation unit 220 may be formed in a plate shape bent in a direction spaced apart from the insertion channel 130. Accordingly, in a state in which the holder 200 applies elastic force to the panel 10 inserted into the insertion channel 130, a user puts a hand between the holder separation unit 220 and the panel 10 so as to apply the force to discharge the holder 200 from the insertion channel 130, so that the state in which the holder 200 applies the elastic force to the panel 10 may be released.

The holder main body 230 between the stress dispersion unit 210 and the holder separation unit 220 may have a pair of bending plates, and the bent portions of the pair of bending plates are in contact with the panel 10 to apply elastic force.

Hereinafter, an operation example of the present disclosure will be described.

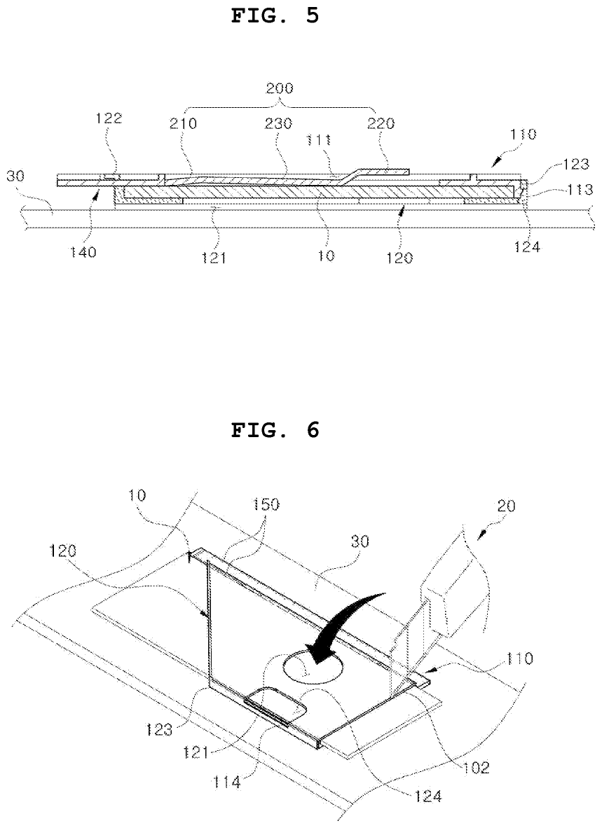

FIGS. 3 to 7 are operational views of the panel cutting jig according to an embodiment of the present disclosure.

Referring back to FIG. 1, the holder 200 is bent toward the insertion channel 130 of the main body 100 to penetrate the insertion channel 130 of the main body 100. Accordingly, only when the holder 200 is discharged from the insertion channel 130 of the main body 100, it is possible to prevent interference between the holder 200 and the panel 10 when the panel 10 is inserted into the insertion channel 130 of the main body 100.

Accordingly, as illustrated in FIG. 3, first, a user applies force for discharging the holder 200 from the insertion channel 130 of the main body 100 through the second opening 121 to discharge the holder 200 from the insertion channel 130 of the main body 100.

Next, the user inserts the panel 10 into the insertion channel 130 of the main body 100 while maintaining the state in which the holder 200 is discharged from the insertion channel 130 of the main body 100. The panel 10 may be easily inserted through the panel insertion hole 101 of the main body 100. Thereafter, when the panel 10 reaches the holder 200 while being continuously inserted into the insertion channel 130, the user releases the state in which the holder 200 is discharged from the insertion channel 130 of the main body 100. As a result, the holder 200 may apply elastic force to press the panel 10 inserted into the insertion channel 130.

Next, the user completely passes the panel 10 through the insertion channel 130 to dispose the cut portion of the panel 10 on the cutting guide 102 of the main body 100.

Next, as illustrated in FIGS. 4 to 5, as the holder 200 applies elastic force to press the panel 10 inserted into the insertion channel 130, the panel 10 inserted into the insertion channel 130 is fixed. The user may cut the panel 10 based on the cutting portion of the panel 10 disposed on the cutting guide 102 of the main body 100 using a cutting mechanism 20. The user additionally applies pressing force to the main body 100 or the holder 200 while disposing the main body 100 into which the panel 10 is inserted on a workbench 30 to firmly fix the panel 10. After fixing, the cutting portion of the panel 10 may be cut. A stationery knife, a chainsaw, and a hacksaw may be used as the cutting mechanism 20.

Next, as illustrated in FIGS. 6 to 7, after the user turns over the main body 100, the panel 10 may be cut based on the cutting portion of the panel 10 disposed on the cutting guide 102 of the main body 100. The user additionally applies pressing force to the main body 100 or the holder 200 while disposing the main body 100 into which the panel 10 is inserted on the workbench 30 to firmly fix the panel 10. After fixing, the cutting portion of the panel 10 may be cut.

Next, the user applies force for discharging the holder 200 from the insertion channel 130 through the holder separation unit 220 to discharge the holder 200 from the insertion channel 130 and release the elastic force applied to a wooden channel by the holder 200.

Finally, the user discharges the panel 10 from the insertion channel 130.

Accordingly, according to the present disclosure, the panel cutting jig according to an embodiment of the present disclosure has the advantage of stably fixing and cutting the panel 10 and making the cutting surface of the panel 10 even.

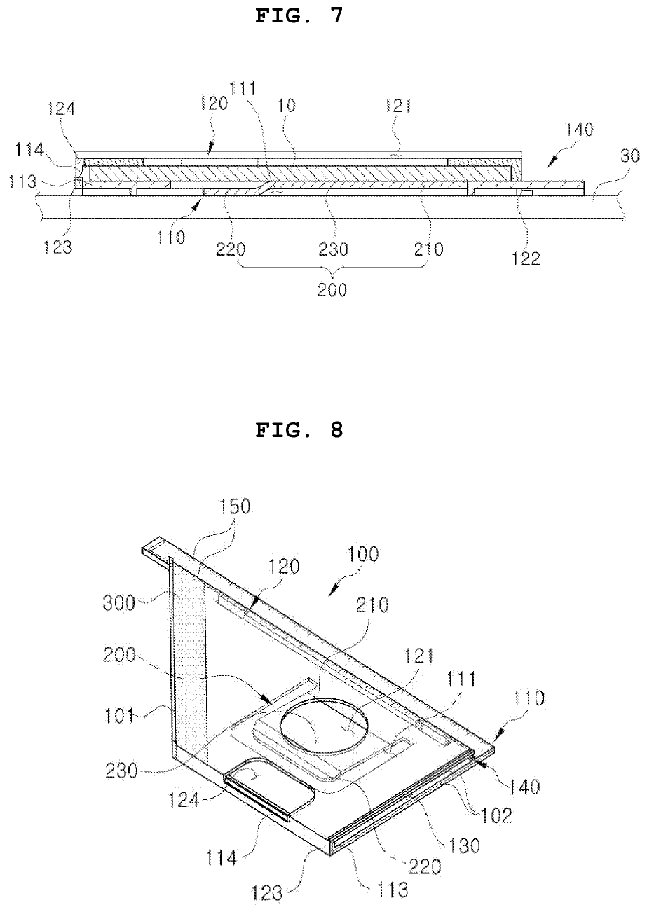

FIG. 8 is a perspective view illustrating a panel cutting jig according to another embodiment of the present disclosure.

As illustrated in FIG. 8, the panel cutting jig according to another embodiment of the present disclosure may further include a surface roughness adjustment unit 300 that may change the surface roughness of the cutting portion of the panel 10, unlike the panel cutting jig according to an embodiment of the present disclosure.

The surface roughness adjustment unit 300 may be sandpaper provided on an outer surface of the main body 100, and a user may change the surface roughness of the cutting portion of the panel 10 by using the sandpaper.

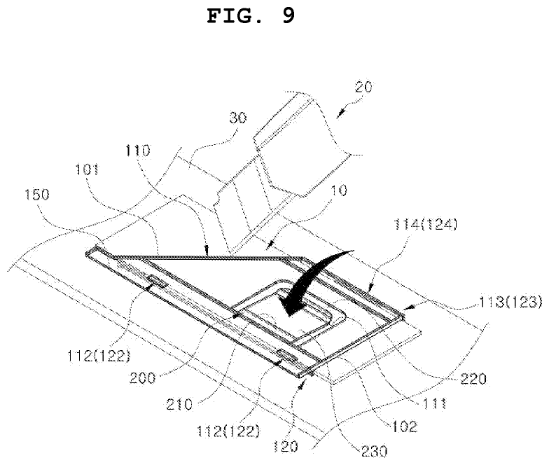

FIG. 9 is another operational view of the panel cutting jig according to an embodiment of the present disclosure.

As illustrated in FIG. 9, a user may cut the panel 10 using the cutting mechanism 20 based on the cutting portion of the panel 10 disposed in the panel insertion hole 101 of the main body 100. Since the panel insertion hole 101 is an inclined surface, the cutting portion of the panel 10 may be formed as an inclined surface.

The panel cutting jig according to the present disclosure may be applied to cutting a plate having a predetermined thickness, and a panel for blind curtains.

Hereinbefore, the present disclosure has been described with reference to the embodiments shown in the accompanying drawings. It will be understood by those skilled in the technical field to which the present disclosure pertains that the present disclosure may be embodied in various other specific forms without departing from the technical ideas or essential characteristics of the present disclosure. Therefore, the disclosed embodiments should be considered in an illustrative rather than a restrictive perspective in all aspects.

1. A panel cutting jig comprising:
a main body having an insertion channel, into which a plate-shaped panel is inserted, formed therein; and
a holder that is elastically deformable and supports the main body to generate elastic force toward the insertion channel.

2. The panel cutting jig of claim 1, further comprising a stress dispersion unit which is provided in the holder and disperses stress due to elastic deformation of the holder.

3. The panel cutting jig of claim 2, further comprising a holder separation unit which is provided in the holder and separates the holder from the insertion channel.

4. The panel cutting jig of claim 1, wherein the main body comprises:
a first body; and
a second body detachably coupled to the first body,
wherein the insertion channel is formed between the first body and the second body.

5. The panel cutting jig of claim 4, wherein:
a first opening in which the holder is disposed is formed in any one of the first body and the second body; and
a second opening facing the holder is formed in the other of the first body and the second body.

6. The panel cutting jig of claim 4, wherein:
a fixing hole is formed in one side of any one of the first body and the second body, and a fixing protrusion inserted into the fixing hole is formed in one side of the other of one side of the first body and the second body; and
a bearing wall is formed in the other side of any one of the first body and the second body, and a support wall borne by the bearing wall is formed in the other side of any one of the first body and the second body.

7. The panel cutting jig of claim 6, wherein:
a locking hole is formed in the bearing wall; and
a locking projection locked and fixed to the locking hole is formed in the support wall.

8. The panel cutting jig of claim 4, wherein a scale is marked in one side of at least any one of the first body and the second body in a length direction of the main body.

9. The panel cutting jig of claim 1, wherein a cutting guide for guiding cutting of the panel inserted into the insertion channel is provided at the main body.

10. The panel cutting jig of claim 1, wherein a panel insertion hole for guiding insertion into the insertion channel is provided at the main body.
